(19) United States
(12) Patent Application Publication
(10) Pub. No.: US 2024/0307915 A1
(43) Pub. Date: Sep. 19, 2024

(54) MACHINE AND METHOD FOR TREATING A WORKPIECE

(71) Applicant: HOMAG GmbH, Schopfloch (DE)

(72) Inventors: Ludwig ALBRECHT, Dornstetten-Aach (DE); Peter WULZINGER, Sulz a. N. (DE)

(21) Appl. No.: 18/278,737

(22) PCT Filed: Feb. 24, 2022
(86) PCT No.: PCT/EP2022/054666

§ 371 Date: Aug. 24, 2023

(30) Foreign Application Priority Data
Feb. 25, 2021 (DE) 10 2021 104 499.5

(51) Int. Cl. B05D 3/06; B05C 9/10; B05C 9/12; B05D 3/12; B05D 3/14; B05D 5/06; B05D 7/00; B27D 5/00; B41J 3/407; B41J 11/00

(52) U.S. Cl. CPC B05D 3/067; B05C 9/10; B05C 9/12; B05D 3/12; B05D 3/148; B05D 5/061; B05D 7/532; B41J 3/407; B41J 11/0015; B27D 5/003

(57) ABSTRACT

Provided is an apparatus for treating a workpiece, in particular a plate-shaped workpiece, said apparatus comprising: a coating device configured to apply a coating material, in particular a strip-shaped coating material, to a workpiece; a lacquer application device configured to apply a lacquer to the coating material; and a structuring device configured to adjust a gloss value and/or a haptic property of the surface provided with the lacquer.

### TECHNICAL FIELD

The invention relates to an apparatus for treating a workpiece, in particular a plate-shaped workpiece. A workpiece of this type which, for example, is used in the field of the components and furniture industry, can be formed at least in parts of wood or wood materials.

### PRIOR ART

Plate-shaped workpieces such as, for example, plates or panels made of wood or wood materials, can be printed using an inkjet printing device to customize or adapt their external appearance.

Document EP 1 726 443 A1 is, for example, known in this context, which describes an apparatus for applying a pattern to the narrow sides of plate-shaped workpieces. The apparatus comprises a stationary printing unit comprising at least one stationary inkjet print head each having a plurality of nozzle orifices for ejecting ink, a conveying device by means of which the workpieces can be conveyed along the printing unit, a detecting device, arranged upstream of the printing unit, for detecting the dimensions and/or the position of the narrow side to which the pattern is to be applied and/or the conveying speed of the workpieces on the conveying device, a memory device in which image data for the pattern to be applied to the narrow side are stored, and a control device which communicates with the print heads, the detecting device and the memory device and is set up to control the print heads as a function of the detected data obtained from the detecting device in such a way that ink is ejected only from nozzle orifices in a printing area, the level of which substantially corresponds to the level of the narrow side to which the pattern is to be applied.

### DESCRIPTION OF THE INVENTION

An object of the invention is to provide an apparatus and a method with which a further improved appearance of the workpiece can be produced.

According to the invention, a corresponding apparatus comprises the features according to claim 1. Further preferred embodiments are specified in the dependent claims.

The apparatus comprises a coating device configured to apply a coating material, in particular a strip-shaped coating material, to a workpiece. Such a coating material may in particular be formed at least in parts of a plastic material, aluminum or a veneer. The apparatus further comprises a lacquer application device configured to apply a lacquer to the coating material, and a structuring device configured to adjust a gloss value and/or haptic properties of the surface provided with lacquer.

It has been shown that using the apparatus according to the invention enables a high-quality and at the same time cost-efficient production on an industrial scale. The apparatus makes it possible in one operation to apply a coating material to the workpiece and to set a surface between high gloss and dull matt. The apparatus moreover has the advantage that each workpiece can be individually designed. A change of the optical design of the workpieces can also take place during operation.

According to a further embodiment, it is provided that the apparatus also comprises a printing device for printing on a surface of the coating material. It is preferred that the printing device is arranged between the coating device and the lacquer application device.

It may thereby be provided that the printing device comprises one or more print heads, with it further being preferred that the print head(s) is/are configured as inkjet print heads. This ensures precise printing and thus also an individual configuration. If multiple print heads are provided, multicolor printing can be carried out.

The lacquer application device may comprise a nozzle for spray application, an inkjet print head and/or a roller. The nozzle and the inkjet print head have the advantage that they work without contact. By contrast, applying lacquer using the roller results in contact between roller and workpiece, with the lacquer being pressed against the workpiece.

The structuring device may be, or include, an excimer lamp, an IR lamp (infrared lamp), a microwave source, and/or an LED source.

The action on the lacquer surface results in polymerization of the lacquer so that the surface is, so to speak, folded. This surface causes a diffuse reflection of the light. The gloss value and optionally haptics are adjusted depending on the change of the surface. An excimer lamp has proved to be successful in creating deep matt surfaces with haptic effects where required. In addition, it was found that a gloss value can also be adjusted precisely by means of an infrared lamp, a microwave source and/or an LED source.

According to one embodiment, it is provided that the apparatus comprises a conveying device configured to move the workpiece in a throughput direction D. A so-called throughfeed machine allows achieving a relatively high throughput. In this regard, it may be further preferred that the conveying device comprises a transport belt, a conveyor chain or a conveyor belt.

The apparatus may comprise a machining unit configured to machine, in particular trim, the surface of the workpiece to be provided with the coating material. The machining unit may comprise one or more machining aggregates, in particular one or more milling aggregates with which machining can be performed. For example, a machining aggregate of the machining unit allows producing a flat surface. The machining unit may further include a machining aggregate to provide a radius or chamfer on the workpiece, particularly on a narrow surface of the workpiece.

According to a further embodiment, the apparatus comprises a finishing device having a trimming aggregate, a scraper and/or a machining aggregate comprising a rotating machining tool. The trimming aggregate and/or the scraper are provided to cut off protruding coating material. The machining aggregate may be configured as a profile milling aggregate with which profile milling can be performed on a rear or front narrow surface of the workpiece.

The apparatus may further comprise a cleaning device configured to clean the coating material, in particular before printing. The quality of the subsequent printing or application processes can thus be improved. In particular, the cleaning device may comprise a circumferential cloth that is moved relative to the coating material applied to the workpiece and thus removes machining residues, dust or the like from the coating material.

According to a further embodiment, the apparatus comprises a plasma treatment device configured to generate a plasma in order to blow the plasma onto the coating material by means of compressed air. This prepares the surface for further processing. In a next step, an adhesion promoter (primer) can be applied to the coating material by means of an adhesion promoter application device. The surface prepared by the plasma treatment device allows the adhesion promoter to adhere particularly well to the surface.

The invention furthermore relates to a method for treating a workpiece, in particular a plate-shaped workpiece. The method comprises the steps of: applying a coating material, in particular a strip-shaped coating material, to a workpiece, applying a lacquer to the coating material, and structuring the surface of the lacquer for adjusting a gloss value and/or a haptic property. It is preferred that the apparatus described above be used within the context of the method.

The coating material is in particular made at least in parts of a plastic material, aluminum, or a veneer, and thus the method can be used in the field of furniture manufacturing.

The method may further comprise the step of printing on a surface of the coating material. The outer appearance can thus be individually designed. The printing on the surface of the coating material takes place in particular prior to the step of applying the lacquer to the coating material.

In a further embodiment, it is provided that the application of the lacquer is carried out by means of a nozzle for spray application, an inkjet print head and/or a roller.

It may be further provided that the structuring is carried out by means of an excimer lamp, an IR lamp, a microwave source and/or an LED source.

It is preferred that the surface of the workpiece to be coated is machined prior to application of the coating material. For example, a flat surface can be produced. Moreover, a radius or chamfer may be provided on the workpiece, particularly on a narrow surface of the workpiece.

As a further step, the method may include finishing the coating material, in particular trimming, removing and/or format machining the coating material applied to the workpiece. Manufacturing can thus be carried out in one operation, in particular in one pass.

It is preferred that the steps for treating the workpiece are performed in one pass. Thus, a coating material can be applied to the workpiece in one operation, and a surface can be adjusted between high gloss and dull matt. This opens up individual design possibilities.

### BRIEF DESCRIPTION OF THE DRAWING

Further features and advantages are apparent with reference to the accompanying drawing.

FIG. 1 shows a schematic view of an apparatus for printing workpieces according to an embodiment of the invention.

### DESCRIPTION OF THE EMBODIMENT

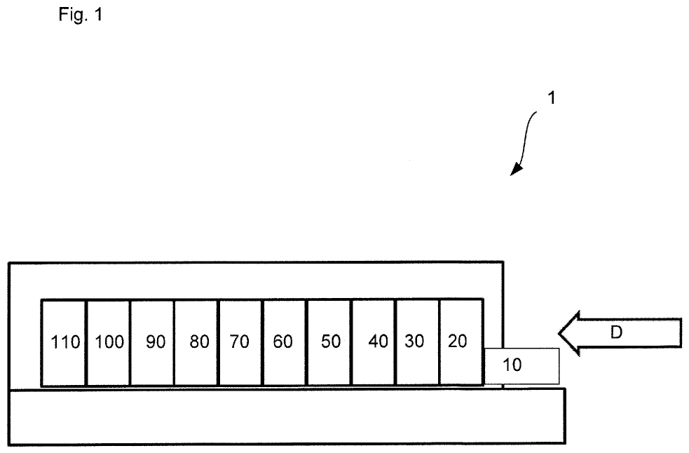

FIG. 1 shows a schematic side view of an embodiment of an apparatus 1 according to the invention, which is used for printing on a narrow side of a plate-shaped workpiece. A workpiece of this type may be made at least in parts of wood or wood materials. For example, it is a plate or a panel for a piece of furniture, a floor or ceiling panel, a kitchen worktop or the like.

For moving the workpieces to be treated by the apparatus 1, the apparatus 1 comprises a conveying device by means of which workpieces can be moved through the apparatus 1 in a throughput direction D. The conveying device is configured, for example, as a transport belt, a conveyor chain or a conveyor belt. The apparatus 1 may be further provided with a so-called top pressure member with which the workpieces moving in the throughput direction D are pressed against the conveying device.

The apparatus 1 includes an infeed area 10 in which a workpiece can be inserted into the apparatus 1. It is also possible to feed workpieces to the infeed area 10 by means of a feed device (not shown).

Located adjacent to the infeed area 10 is a machining unit 20 configured to machine, in particular trim, a narrow surface of a workpiece moved in the throughfeed direction D. The machining unit 20 comprises one or more machining aggregates with which machining can be performed. For example, a machining aggregate of the machining unit 20 can be used to produce a flat surface. The machining unit 20 may further comprise a machining aggregate to provide a radius or a chamfer on a narrow surface of the workpiece.

In the throughput direction D, downstream of the machining unit 20, the apparatus 1 comprises a coating device 30 configured to apply a strip-shaped coating material to the narrow surface of the plate-shaped workpiece machined by the machining unit 20. Such a coating material comprises either a pre-coated adhesive layer or an activatable portion, or the coating material and/or the narrow surface of the workpiece is/are provided with an adhesive. The coating device 30 is configured to press the coating material against the narrow side of the workpiece.

Provided downstream of the coating device 30 is a finishing device 40 with which a projecting portion of the coating material can be removed and/or it is ensured that the coating material is flush with the workpiece dimensions. The finishing device 40 may comprise a trimming aggregate and/or a scraper that is/are configured to cut off protruding coating material. Alternatively or additionally, the finishing device 40 comprises a profile milling aggregate with which profile milling on a rear or front narrow surface of the workpiece is carried out.

The apparatus 1 further comprises a cleaning device 50 in order to clean the workpiece, in particular the coated narrow surface of the workpiece, prior to further processing. The cleaning device 50 may, in particular, comprise a circumferential cloth that is moved relative to the coating material applied to the narrow side of the workpiece and thus removes machining residues, dust or the like from the coating material.

The apparatus 1 further comprises a plasma treatment device 60 configured to generate a plasma, spatially separated from a high-voltage discharge, so as to blow the plasma onto the coating material on the workpiece by means of compressed air. In the course of this, the surface is slightly heated.

Provided downstream of the plasma treatment device 60, in the throughput direction D, is an adhesion promoter application device 70 with which a promoter (primer) is applied to the coating material. Using the adhesion promoter application device 70, the surface of the coating material provided on the workpiece is prepared for subsequent printing such that the surface has improved wetting and adhesion properties.

Provided adjacent to the adhesion promoter application device 70 is an inkjet printing device 80 comprising one or more print heads. The print heads are configured as inkjet print heads and can apply a printing material (ink) on the surface to be printed. The inkjet print head of the inkjet printing device 80 can perform multicolor printing and output the colors black, magenta, yellow, and cyan for this purpose. These colors are appropriately combined with each other to apply a multicolored pattern due to their combination.

Provided downstream of the inkjet printing device 80, in the throughput direction D, is a lacquer application device 90 that can apply lacquer to the printed surface of the workpiece. The lacquer application device 90 may comprise a nozzle for spray application, an inkjet print head, or a roller.

Provided adjacent to the lacquer application device 90 is a structuring device 100 comprising an excimer lamp. The structuring device 100 allows a targeted structuring of the lacquer that has not yet cured or has not completely cured, so that a specific gloss value and/or haptic properties of the surface can be adjusted. The gloss value can be measured as a reflectometer value according to ISO 2813. Moreover, owing to the use of the structuring device 100, a specific haptics is produced and the lacquer is further hardened.

Provided downstream in the throughput direction D is further an inspection device 110 comprising a camera to inspect the surface of the workpiece treated by the aforementioned devices, in particular the surface of the coating material on the workpiece printed and treated by the structuring device 100, and to assess the surface quality.

The apparatus 1 has the advantage that the aforementioned devices 20 to 100 are provided in one apparatus, so that the workpiece can pass through a plurality of machining steps without further realignment and, in particular, in one clamping operation. This increases the reproducibility and the quality of the external appearance of the workpiece since the respective machining steps can be precisely coordinated with one another.

1. An apparatus for treating a workpiece, comprising:
a coating device configured to apply a coating material to a workpiece;
a lacquer application device configured to apply a lacquer to the coating material; and
a structuring device configured to adjust a gloss value or a haptic property of the surface provided with the lacquer.

2. The apparatus according to claim 1, further comprising a printing device configured to print on a surface of the coating material.

3. The apparatus according to claim 1, wherein the lacquer application device comprises a nozzle for spray application, an inkjet print head, or a roller.

4. The apparatus according to claim 1, wherein the structuring device comprises an excimer lamp, an IR lamp, a microwave source, or an LED source.

5. The apparatus according to claim 1, further comprising a conveying device configured to move the workpiece in a throughput direction.

6. The apparatus according to claim 1, further comprising a machining unit configured to trim the surface of the workpiece to be provided with the coating material.

7. The apparatus according to claim 1, further comprising a finishing device having a trimming aggregate, a scraper or a machining aggregate comprising a rotating machining tool.

8. The apparatus according to claim 1, further comprising a cleaning device configured to clean the coating material applied to the workpiece.

9. The apparatus according to claim 1, further comprising a plasma treatment device configured to generate a plasma in order to blow the plasma onto the coating material applied to the workpiece by means of compressed air.

10. A method for treating a workpiece, comprising the steps of:
applying a coating material to a workpiece;
applying a lacquer to the coating material; and
structuring the surface of the lacquer for adjusting a gloss value or a haptic property.

11. The method according to claim 10, further comprising the step of printing on a surface of the coating material.

12. The method according to claim 10, wherein the application of the lacquer is carried out by means of a nozzle for spray application, an inkjet print head or a roller.

13. The method according to claim 10, wherein the structuring is carried out by means of an excimer lamp, an IR lamp, a microwave source, or an LED source.

14. The method according to claim 10, wherein prior to application of the coating material, the surface of the workpiece to be coated is machined.

15. The method according to claim 10, wherein the steps for treating the workpiece are carried out in one pass.

16. The apparatus according to claim 2, wherein the printing device comprises at least one print head.

17. The apparatus according to claim 5, wherein the conveying device comprises a transport belt, a conveyor chain, or a conveyor belt.

18. The method according to claim 10, wherein the workpiece comprises a plate-shaped workpiece and the coating material comprises a strip-shaped coating material.
